(19) United States
(12) Patent Application Publication
(10) Pub. No.: US 2010/0097521 A1
(43) Pub. Date: Apr. 22, 2010

(54) VIDEO-SIGNAL PROCESSING APPARATUS, VIDEO-SIGNAL PROCESSING METHOD, VIDEO-SIGNAL PROCESSING COMPUTER PROGRAM, AND VIDEO-SIGNAL CONTROL CIRCUIT

(75) Inventors: Teruyuki SATO, Kawasaki (JP); Kohji Yamada, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/577,298

(22) Filed: Oct. 12, 2009

(30) Foreign Application Priority Data
Oct. 22, 2008 (JP) 2008-272425

(51) Int. Cl. H04N 7/01

(52) U.S. Cl. 348/452; 348/E07.003

(57) ABSTRACT

A video-signal processing apparatus includes a frame interpolation unit, a specific-scene detecting unit, and an output-timing control unit. If the specific-scene detecting unit detects that a second original image frame corresponds to a specific scene, the output-timing control unit outputs the second original image frame and an interpolated frame to a display unit at timing with delay from original output timing, and if the specific-scene detecting unit detects that the second original image frame does not correspond to the specific scene, the output-timing control unit outputs the second original image frame and the interpolated frame to the display unit at the original output timing.

### CROSS-REFERENCE TO RELATED APPLICATION

This application is based upon and claims the benefit of priority of the prior Japanese Patent Application No. 2008-272425, filed on Oct. 22, 2008, the entire contents of which are incorporated herein by reference.

### FIELD

The embodiments discussed herein are directed to a video-signal processing apparatus, a video-signal processing method, a video-signal processing computer program, and a video-signal control circuit.

### BACKGROUND

A conventional image display device such as a liquid crystal display (LCD) device has a double-speed display function by which an interpolated frame is inserted between original image frames generated based on an actual video signal. For example, the double-speed display function can be included in an image display device that displays an image by ISDB-T (Integrated Services Digital Broadcasting-Terrestrial) one-segment broadcasting with a low frame rate. The image display device having the double-speed display function can display an image with smooth movement even based on a video signal with a low frame rate.

In the image display device having the double-speed display function, there can occur a problem that an operation for generating an interpolated frame is performed too late so that the interpolated frame may not be output to a display unit at predetermined timing. This problem will be explained in detail with reference to FIG. 10. FIG. 10 is a schematic diagram for explaining video signal processing performed by a conventional image display device.

In the example illustrated in FIG. 10, the image display device generates an original image frame F12 by performing a decoding operation and then generates an interpolated frame F11-12 that interpolates between an original image frame F11 and the original image frame F12. Originally, the interpolated frame F11-12 is to be output at timing t1 after the original image frame F11 is output. However, because the interpolated frame F11-12 is generated at timing t2 later than the timing t1, the image display device may not output the interpolated frame F11-12. For the same reason, the image display device may not output interpolated frames F12-13 and F13-14. In the following description, an interpolated frame Fn1-n2 indicates an interpolated frame that interpolates between an original image frame Fn1 and an original image frame Fn2.

Technologies for preventing the above problem are disclosed in, for example, Japanese Laid-open Patent Publication No. 2005-101818, Japanese Laid-open Patent Publication No. 2003-92761, Japanese Laid-open Patent Publication No. 10-200860, and Japanese Laid-open Patent Publication No. 2001-128171. For example, output timing of an image and a voice is delayed in whole, so that the operation for generating the interpolated frame can be performed in time to output the interpolated frame at predetermined timing. Furthermore, delay of the operation for generating the interpolated frame is measured whereby the operation for generating the interpolated frame is started at earlier timing.

However, in the technology in which the output timing is delayed in whole, there is a problem that although an image needs to be displayed in real time, it is difficult to display the image without delay. For example, if an image (a clock) for notifying a user of a time is displayed, an image display device employing the above technology has a problem that the clock is displayed with delay.

In the technology in which the operation for generating the interpolated frame is started at earlier timing, it is assumed that video signals can be completely stored in the media like the DVD, HDD, or flash memory devices, in the case where an off-line operation for reproducing a video file can be performed. Therefore, such a technology may not be applied if it is difficult to completely store video signals as in the case of an image that needs to be displayed in real time.

### SUMMARY

According to an aspect of an embodiment of the present invention, a video-signal processing apparatus includes a frame interpolation unit that generates an interpolated frame that interpolates between a first original image frame and a second original image frame, the first original image frame and the second original image frame being generated based on a video signal and to be output to a display unit at first timing; a specific-scene detecting unit that detects whether the first original image frame and the second original image frame correspond to a specific scene in which an image is moved at a constant speed; and an output-timing control unit that, if the specific scene is detected by the specific-scene detecting unit, outputs the second original image frame and the interpolated frame generated by the frame interpolation unit to the display unit at second timing with delay from the first timing, and if the specific scene is not detected by the specific-scene detecting unit, outputs the second original image frame and the interpolated frame generated by the frame interpolation unit to the display unit at the first timing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are schematic diagrams for explaining video signal processing performed by a video-signal processing apparatus according to an embodiment;

FIG. 2 is a block diagram of the video-signal processing apparatus;

FIG. 3 is a block diagram of an image-frame control unit illustrated in FIG. 2;

FIG. 4 is a diagram for explaining a specific-scene detection operation performed by a specific-scene detecting unit illustrated in FIG. 3;

FIG. 5 is a schematic diagram for explaining an output-timing control operation performed by an output-timing control unit illustrated in FIG. 3;

FIGS. 6A and 6B are schematic diagrams for explaining a data deletion operation performed by an output buffer illustrated in FIG. 3;

FIG. 7 is a flowchart of the video signal processing performed by the video-signal processing apparatus;

FIG. 8A is a flowchart of the specific-scene detection operation performed by the specific-scene detecting unit;

FIG. 8B is a transition diagram of a status controlled by the specific-scene detecting unit;

FIG. 9 is a block diagram of a computer that executes a video-signal processing computer program; and

FIG. 10 is a schematic diagram for explaining video signal processing performed by a conventional image display device.

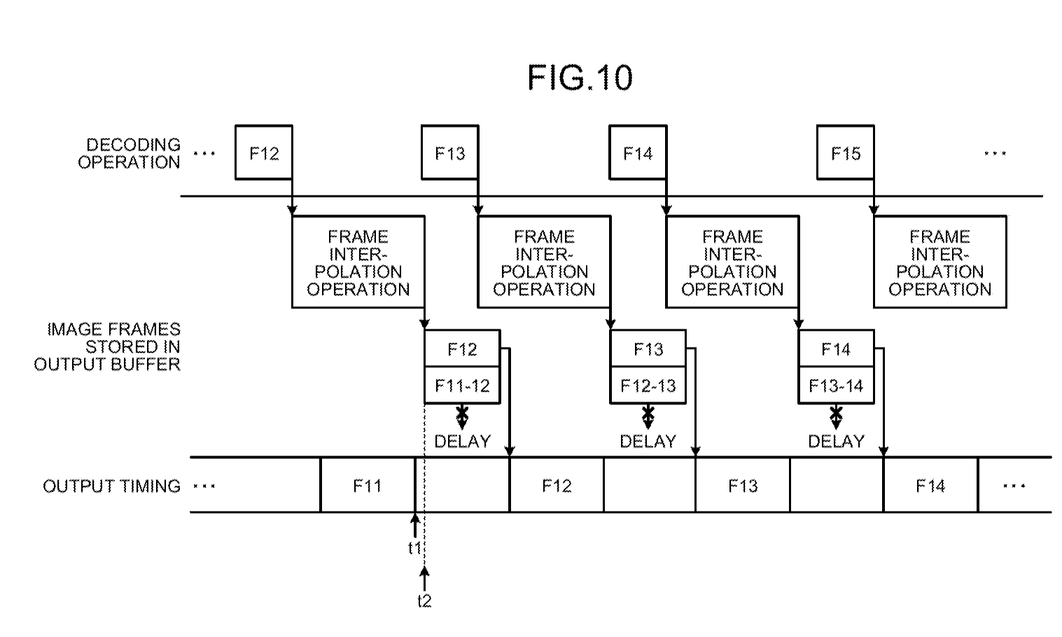

### DESCRIPTION OF EMBODIMENTS

In the following description, a video-signal processing apparatus, a video-signal processing method, a video-signal processing computer program, and a video-signal control circuit according to embodiments of the present invention will be explained in detail below with reference to the accompanying drawings. A video-signal processing apparatus, a video-signal processing method, a video-signal processing computer program, and a video-signal control circuit according to the present invention are not limited to those described in the embodiments.

A video signal processing performed by an video-signal processing apparatus 100 according to an embodiment of the present invention will be explained below. The video-signal processing apparatus 100 detects a scene (hereinafter, “specific scene”) in which quality degradation is noticeable when frame drop occurs from scenes included in an image to be displayed. Specifically, the video-signal processing apparatus 100 detects a scene that is obtained by, for example, panning or tilting a camera and is moved by scrolling at a constant speed on a screen as the specific scene. This is because, if the frame drop occurs, an image obtained by panning or tilting the camera can have noticeable quality degradation such that the image is not displayed with smooth movement. The video-signal processing apparatus 100 outputs an original image frame that corresponds to the specific scene and an interpolated frame to a display unit with delay from original (or regular) output timing.

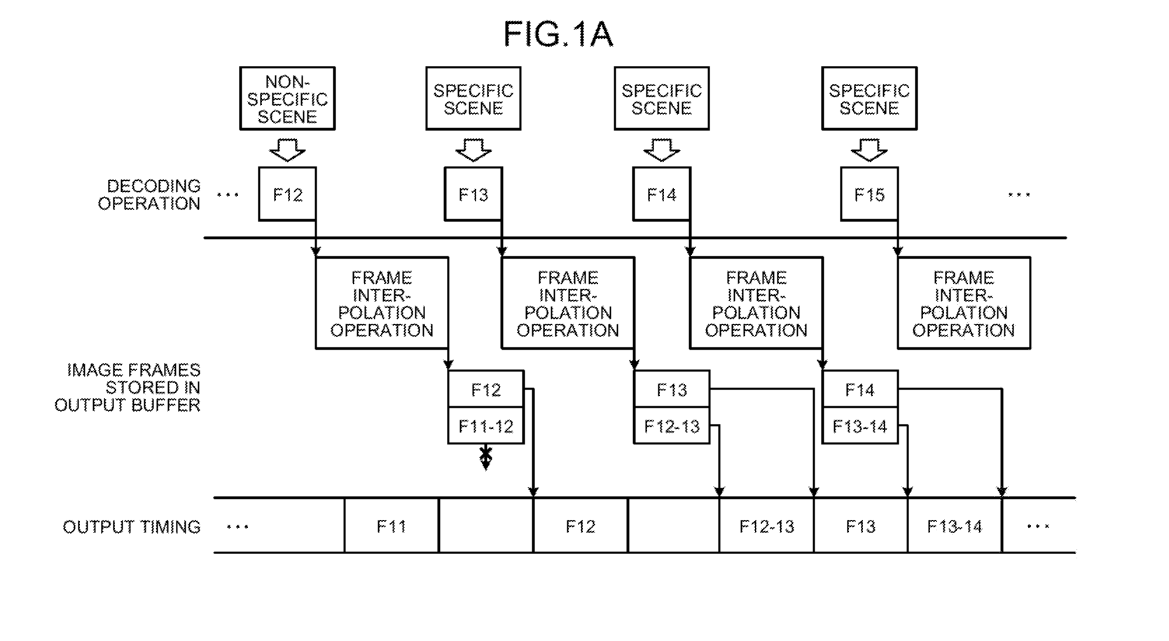

Concrete descriptions will be given with reference to FIGS. 1A and 1B. FIGS. 1A and 1B are schematic diagrams for explaining video signal processing performed by the video-signal processing apparatus 100. As illustrated in FIG. 1A, the video-signal processing apparatus 100 generates the original image frame F12 by performing the decoding operation and then generates the interpolated frame F11-12. Then, the video-signal processing apparatus 100 sequentially stores the interpolated frame F11-12 and the original image frame F12 in an output buffer.

At this time, the video-signal processing apparatus 100 determines whether the original image frame F12 corresponds to the specific scene. Specifically, the video-signal processing apparatus 100 detects a movement vector (or motion vector) between original image frames (for example, the original image frame F11 and the original image frame F12) and determines whether the original image frame F12 corresponds to the specific scene based on the detected movement vector. It is assumed that the video-signal processing apparatus 100 determines that the original image frame F12 does not correspond to the specific scene. A specific-scene detection operation performed by the video-signal processing apparatus 100 will be explained in detail later.

The video-signal processing apparatus 100 then outputs the interpolated frame F11-12 and the original image frame F12 from the output buffer to the display unit in the order they are stored in the output buffer. However, because the interpolated frame F11-12 is generated too late so that the interpolated frame F11-12 may not be output at predetermined timing, the video-signal processing apparatus 100 deletes the interpolated frame F11-12 without outputting the interpolated frame F11-12 to the display unit and then outputs the original image frame F12.

Afterward, the video-signal processing apparatus 100 generates an original image frame F13 by performing the decoding operation and then generates the interpolated frame F12-13. The video-signal processing apparatus 100 then sequentially stores the interpolated frame F12-13 and the original image frame F13 in the output buffer. The video-signal processing apparatus 100 then determines whether the original image frame F13 corresponds to the specific scene. It is assumed that the video-signal processing apparatus 100 determines that the original image frame F13 corresponds to the specific scene.

In such a case, the video-signal processing apparatus 100 outputs the interpolated frame F12-13 and the original image frame F13 to the display unit with delay from original output timing. As illustrated in FIG. 1A, the video-signal processing apparatus 100 outputs the interpolated frame F12-13 and the original image frame F13 with delay corresponding to one frame.

Afterward, the video-signal processing apparatus 100 generates an original image frame F14 by performing the decoding operation and then generates the interpolated frame F13-14. The video-signal processing apparatus 100 then sequentially stores the interpolated frame F13-14 and the original image frame F14 in the output buffer. It is assumed that the video-signal processing apparatus 100 determines that the original image frame F14 corresponds to the specific scene. The video-signal processing apparatus 100 then outputs the interpolated frame F13-14 and the original image frame F14 to the display unit with delay from original output timing.

As illustrated in FIG. 1B, the video-signal processing apparatus 100 generates an original image frame F17 by performing the decoding operation and then generates an interpolated frame F16-17. The video-signal processing apparatus 100 then sequentially stores the interpolated frame F16-17 and the original image frame F17 in the output buffer. It is assumed that the video-signal processing apparatus 100 determines that the original image frame F17 does not correspond to the specific scene.

In such a case, the video-signal processing apparatus 100 deletes the interpolated frame F16-17 without outputting the interpolated frame F16-17 to the display unit and then outputs the original image frame F17 to the display unit at original output timing. In the same manner, the video-signal processing apparatus 100 determines that an original image frame F18 and the original image frame F17 do not correspond to the specific scene and outputs the original image frames F17 and F18 to the display unit at original output timing.

As described above, each time the video-signal processing apparatus 100 generates the original image frame and the interpolated frame, the video-signal processing apparatus 100 determines whether the original image frame corresponds to the specific scene. The video-signal processing apparatus 100 outputs the original image frame that corresponds to the specific scene and the interpolated frame that interpolates the original image frame to the display unit with delay. In this manner, the video-signal processing apparatus 100 can prevent occurrence of noticeable quality degradation when the frame drop occurs with respect to the specific scene. As a result, the video-signal processing apparatus 100 can display the specific scene such that an image can be displayed with smooth movement.

The video-signal processing apparatus 100 outputs the original image frame that does not correspond to the specific scene and the interpolated frame that interpolates the original image frame at original output timing. In this manner, the video-signal processing apparatus 100 can allow a scene in which quality degradation is unnoticeable even when the frame drop occurs to be displayed in real time.

That is, if an image needs to be displayed in real time, the video-signal processing apparatus 100 can display the image almost in real time. Specifically, the video-signal processing apparatus 100 can display, in real time, a scene other than the specific scene included in an image that needs to be displayed in real time. Because the video-signal processing apparatus 100 does not detect a scene including, for example, a clock with little movement as the specific scene, the video-signal processing apparatus 100 can display the scene including the clock in real time.

Thus, the video-signal processing apparatus 100 can display an image with smooth movement and also display a predetermined image (scene) in real time.

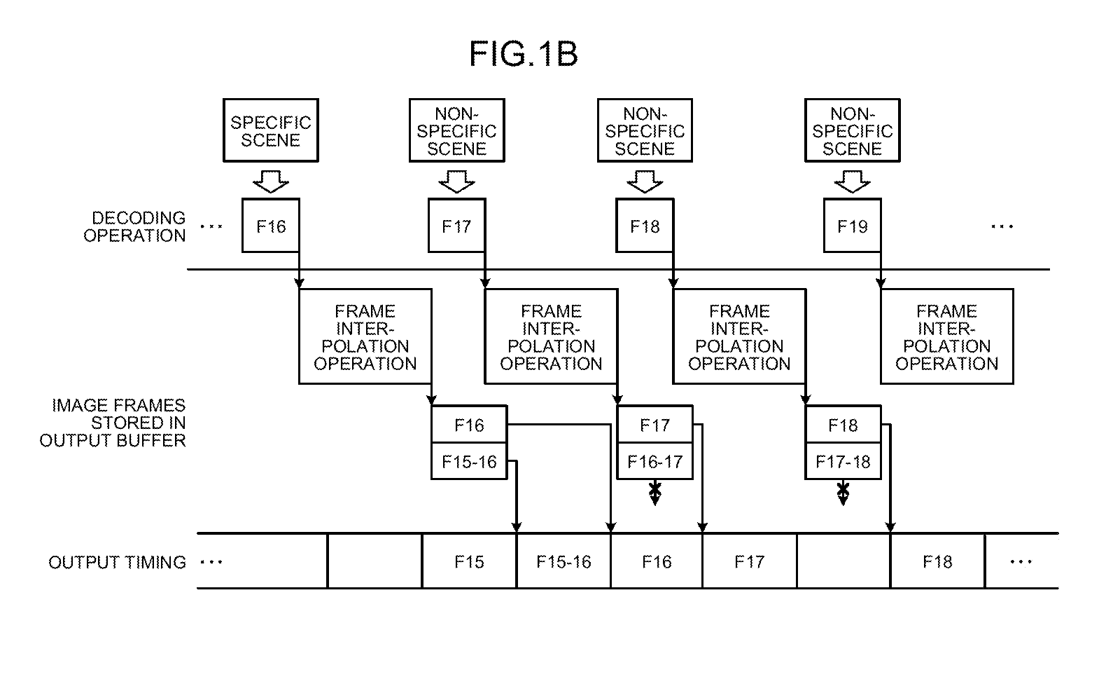

The configuration of the video-signal processing apparatus 100 will be explained below. FIG. 2 is a block diagram of the video-signal processing apparatus 100. The video-signal processing apparatus 100 includes a separating unit 110, a voice decoding unit 120, a voice output unit 130, an image decoding unit 140, a frame interpolation unit 150, an image-frame control unit 160, and an image display unit 170.

The separating unit 110 separates coded video data into coded voice data and coded image data. It is possible that the video-signal processing apparatus 100 stores video data in a storage unit (not illustrated) or receives video data from a different device (for example, an image delivery device) via a network.

The voice decoding unit 120 decodes the coded voice data separated by the separating unit 110. The voice output unit 130 outputs voice data decoded by the voice decoding unit 120. Although not illustrated, the voice output unit 130 outputs the voice data via a voice output device such as a speaker.

The image decoding unit 140 decodes the coded image data separated by the separating unit 110. Specifically, the image decoding unit 140 decodes the coded image data by each frame thereby generating an original image frame. The image decoding unit 140 then outputs the generated original image frame to the frame interpolation unit 150. As illustrated in FIGS. 1A and 1B, the image decoding unit 140 generates the original image frames F11 to F19.

The frame interpolation unit 150 generates an interpolated frame that interpolates between original image frames generated by the image decoding unit 140. Specifically, the frame interpolation unit 150 detects a movement vector between original image frames received from the image decoding unit 140. The frame interpolation unit 150 then generates an interpolation pixel by using the detected movement vector thereby generating an interpolated frame. The frame interpolation unit 150 then outputs the original image frame, the interpolated frame, and movement vector information to the image-frame control unit 160.

As illustrated in FIGS. 1A and 1B, the frame interpolation unit 150 generates the interpolated frame F11-12 that interpolates between the original image frame F11 and the original image frame F12. In the same manner, the frame interpolation unit 150 generates the interpolated frames F12-13, F13-14, F15-16, F16-17, and F17-18.

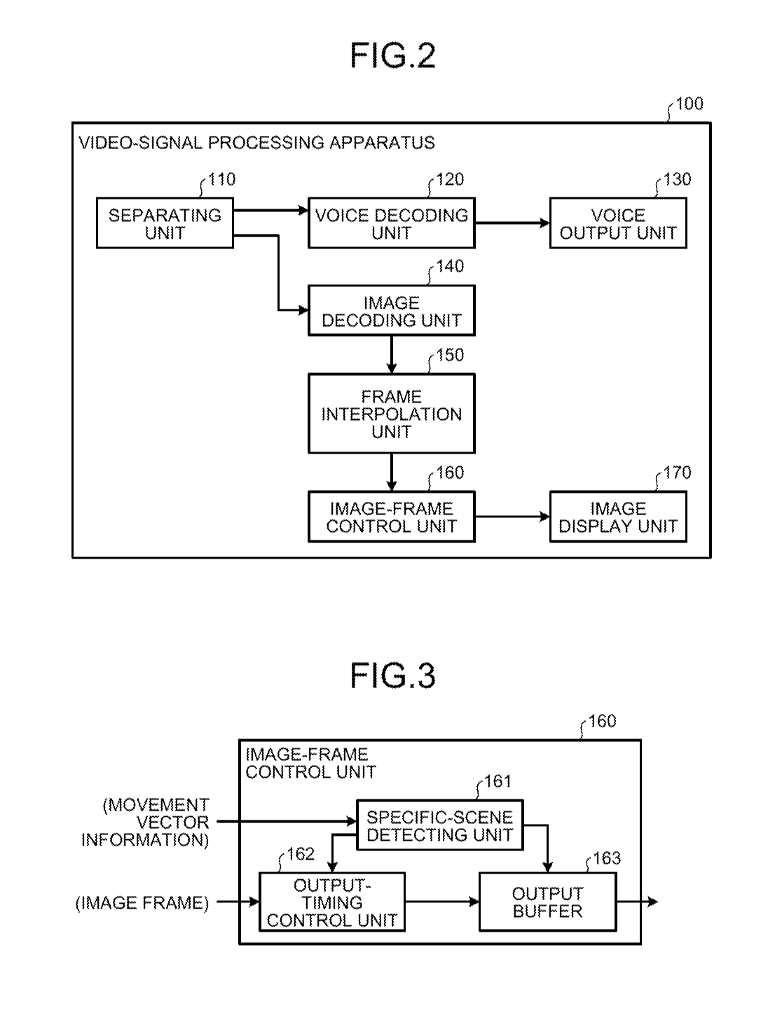

The image-frame control unit 160 controls timing at which the original image frame generated by the image decoding unit 140 and the interpolated frame generated by the frame interpolation unit 150 are to be output to the image display unit 170. The configuration of the image-frame control unit 160 will be explained in detail later with reference to FIG. 3.

The image display unit 170 outputs the original image frame and the interpolated frame at output timing controlled by the image-frame control unit 160. Although not illustrated, the image display unit 170 outputs the original image frame and the interpolated frame via the display unit such as a liquid-crystal display device.

The configuration of the image-frame control unit 160 depicted in FIG. 2 will be explained below. FIG. 3 is a block diagram of the image-frame control unit 160. The image-frame control unit 160 includes a specific-scene detecting unit 161, an output-timing control unit 162, and an output buffer 163.

The specific-scene detecting unit 161 detects whether the original image frame corresponds to the specific scene based on the movement vector information received from the frame interpolation unit 150. The specific-scene detecting unit 161 outputs a detection result to the output-timing control unit 162.

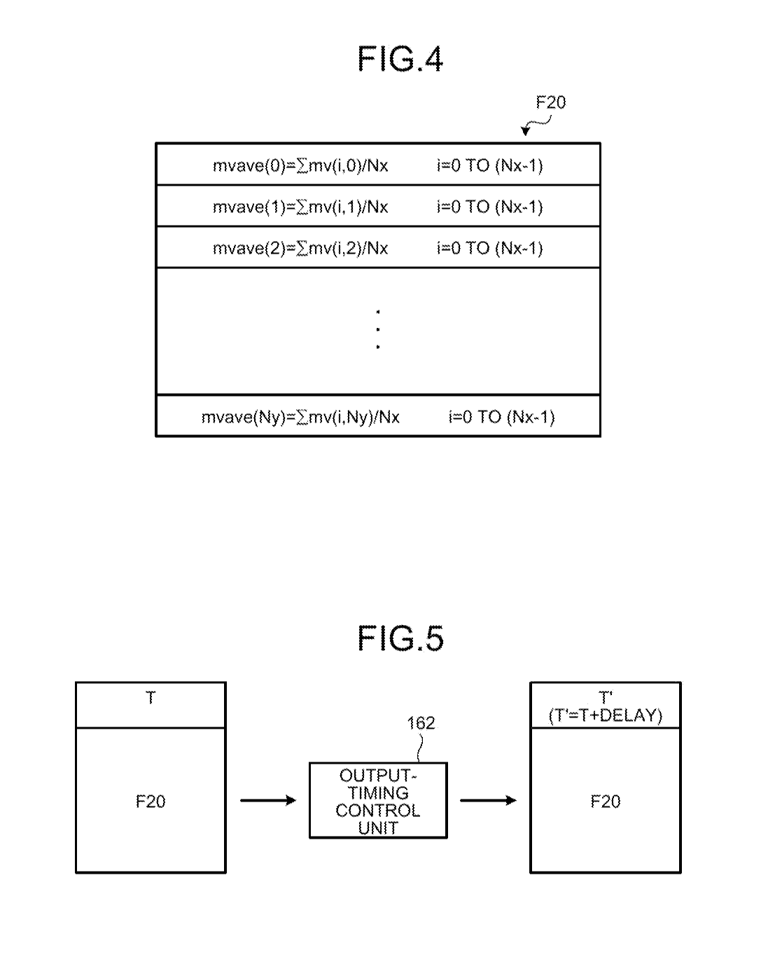

The specific-scene detection operation performed by the specific-scene detecting unit 161 will be explained in detail with reference to FIG. 4. FIG. 4 is a diagram for explaining the specific-scene detection operation performed by the specific-scene detecting unit 161. The specific-scene detecting unit 161 calculates an average value of a movement vector mv(x, y) at coordinates (x, y) in an original image frame F20 by each line (in the x-axis direction or in a lateral direction). The calculated average value indicates an average movement vector mvave in each line and is expressed by Equation (1):

mvave(i)=Σmv(i,0)/Nx (1)

where “i” indicates a value of the x coordinate and can be a value from “0” to “Nx−1”.

The specific-scene detecting unit 161 then calculates an average value of all of average movement vectors mvave(i). The calculated average value indicates an overall average movement vector mvaveall in the original image frame F20 and is expressed by Equation (2):

mvaveall=Σmvave(j)/Ny (2)

where “j” indicates a value of the y coordinate and can be a value from “0” to “Ny−1”.

The specific-scene detecting unit 161 then calculates Σ|mvave(i)−mvaveall| that is a value indicating a degree of variation or dispersion of the average movement vector mvave(i). The calculated value indicating the degree of variation is referred to as “movement vector variance”.

The specific-scene detecting unit 161 detects that the original image frame F20 corresponds to the specific scene if a value of the movement vector variance is smaller than a threshold and the overall average movement vector mvaveall is not zero. This is because, if the value of the movement vector variance is sufficiently small, it means that the average movement vector mvave(i) in each line does not vary and therefore it indicates that the original image frame F20 is moved in the same direction for the same movement distance as the previous original image frame. Furthermore, this is because, if the overall average movement vector mvaveall is not zero, it means that an image displayed in the screen is not still.

On the other hand, the specific-scene detecting unit 161 detects that the original image frame F20 corresponds to the specific scene if the value of the movement vector variance is larger than the threshold or if the overall average movement vector mvaveall is zero. This is because, if the value of the movement vector variance is larger than the threshold, it means that the average movement vector mvave(i) in each line varies and therefore it indicates that an image included in a scene is not scrolled at a constant speed on the screen. Furthermore, if the overall average movement vector mvaveall is zero, it means that an image displayed on the screen is still.

As described above, the specific-scene detecting unit 161 can determine whether a target original image frame is moved in the same direction for the same movement distance as the previous original image frame by using the movement vector variance. Moreover, the specific-scene detecting unit 161 determines whether the overall average movement vector mvaveall is zero thereby determining whether an image displayed on the screen is still in the target original image frame in comparison with the previous original image frame.

If the specific-scene detecting unit 161 detects that the original image frame does not correspond to the specific scene and if the previous original image frame corresponds to the specific scene, the specific-scene detecting unit 161 outputs a signal (hereinafter, “buffer control signal”) for instructing all or a part of data to be deleted to the output buffer 163. This is because, if an original image frame and an interpolated frame are to be output at original output timing after a predetermined original image frame and a predetermined interpolated frame are output with delay, some original image frame and interpolated frame may not be displayed.

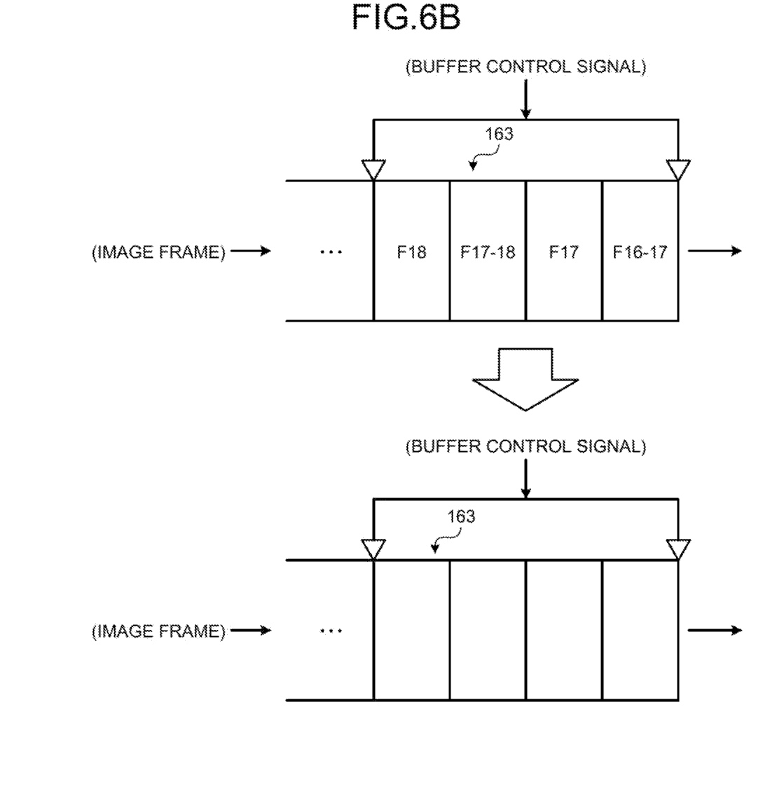

For example, as illustrated in FIG. 1B, after the original image frame F16 is output with delay, the specific-scene detecting unit 161 detects that the original image frame F17 does not correspond to the specific frame. In such a case, even if the video-signal processing apparatus 100 desires to output the original image frame F17 at original output timing, the video-signal processing apparatus 100 may not output the original image frame F17 at the original output timing because the previous interpolated frame F16-17 is to be output at the same output timing as that of the original image frame F17. Therefore, the specific-scene detecting unit 161 outputs the buffer control signal to delete the interpolated frame F16-17 from the output buffer 163. An operation for deleting data from the output buffer 163 will be explained in detail later with reference to FIGS. 6A and 6B.

The output-timing control unit 162 controls timing at which image frames (an original image frame and an interpolated frame) received from the frame interpolation unit 150 are to be output to the display unit based on a detection result received from the specific-scene detecting unit 161.

Specifically, if the detection result received from the specific-scene detecting unit 161 indicates that the original image frame corresponds to the specific scene, the output-timing control unit 162 delays timing at which the original image frame and the interpolated frame are to be output to the display unit. For example, as illustrated in FIG. 1A, if the detection result received from the specific-scene detecting unit 161 indicates that the original image frame F13 corresponds to the specific scene, the output-timing control unit 162 delays timing at which the interpolated frame F12-13 and the original image frame F13 are to be output.

On the other hand, if the detection result received from the specific-scene detecting unit 161 indicates that the original image frame does not correspond to the specific scene, the output-timing control unit 162 controls output timing of the original image frame and the interpolated frame such that the original image frame and the interpolated frame are to be output to the display unit at original output timing. For example, as illustrated in FIG. 1A, if the detection result received from the specific-scene detecting unit 161 indicates that the original image frame F12 does not correspond to the specific scene, the output-timing control unit 162 controls output timing of the interpolated frame F11-12 and the original image frame F12 such that the interpolated frame F11-12 and the original image frame F12 are to be output to the display unit at original output timing. The output-timing control unit 162 outputs the original image frame and the interpolated frame to the output buffer 163 after the output-timing control unit 162 controls the output timing of the original image frame and the interpolated frame.

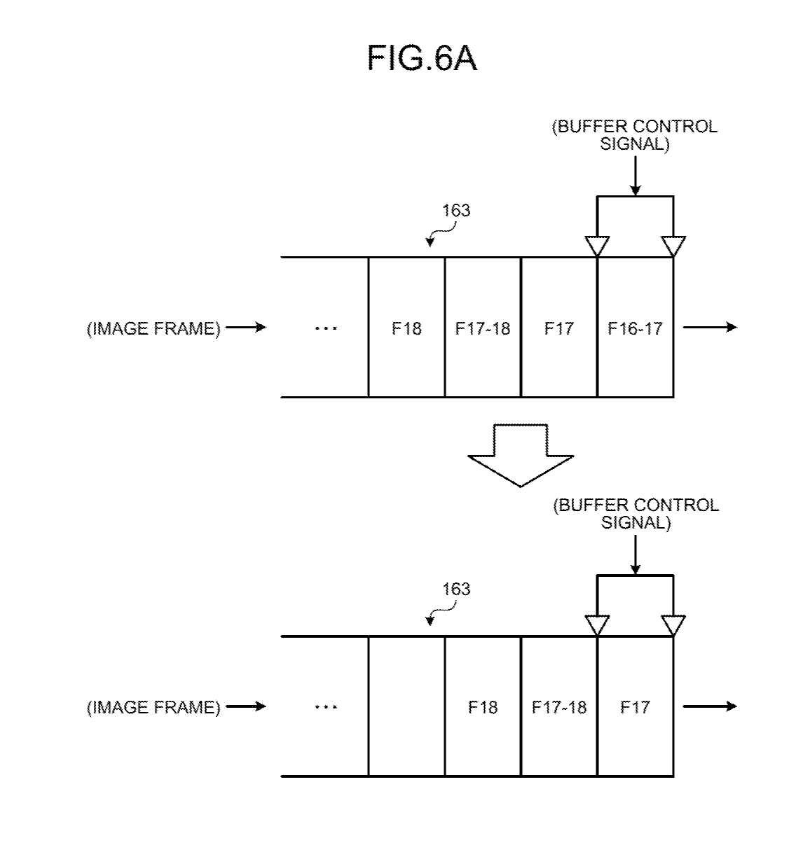

An output-timing control operation performed by the output-timing control unit 162 will be explained in detail with reference to FIG. 5. FIG. 5 is a schematic diagram for explaining the output-timing control operation performed by the output-timing control unit 162. A rectangle illustrated in FIG. 5 indicates the original image frame F20. An upper rectangle illustrated in FIG. 5 indicates timing (time stump) at which the original image frame F20 is to be output to the display unit, and a lower rectangle illustrated in FIG. 5 indicates image data about the original image frame F20.

In the example illustrated in FIG. 5, it is assumed that the output-timing control unit 162 receives, from the specific-scene detecting unit 161, the original image frame F20 that is to be output at output timing T and the detection result indicating that the original image frame F20 corresponds to the specific scene. In such a case, the output-timing control unit 162 changes the output timing T to output timing T'. The output timing T′ indicates “the output timing T+delay”. Although the delay needs to be longer than half of an interval at which frames are output, a value of the delay depends on a system configuration. For example, a longer delay is needed if the decoding operation and the frame interpolation operation are performed for a group of frames than if these operations are sequentially performed for each frame. The output-timing control unit 162 controls settings for a time stamp (in the above example, the output timing T or T′) that indicates output timing of each frame.

The output buffer 163 is a storage device that manages data by the first-in first-out (FIFO) method. The output buffer 163 stores therein an original image frame and an interpolated frame in the order they are received from the output-timing control unit 162. The original image frame and the interpolated frame stored in the output buffer 163 are output to the image display unit 170 by the image-frame control unit 160 at output timing (for example, the output timing T′ in the example illustrated in FIG. 5).

Furthermore, if the output buffer 163 receives the buffer control signal from the specific-scene detecting unit 161, the output buffer 163 deletes all or a part of data stored in the output buffer 163 in accordance with the buffer control signal.

A data deletion operation performed by the output buffer 163 will be explained in detail with reference to FIGS. 6A and 6B. FIGS. 6A and 6B are schematic diagrams for explaining the data deletion operation performed by the output buffer 163. As illustrated in FIG. 6A, the output buffer 163 stores therein the interpolated frame F16-17, the original image frame F17, the interpolated frame F17-18, and the original image frame F18 in this order. In the example illustrated in FIG. 6A, if the output buffer 163 receives the buffer control signal from the specific-scene detecting unit 161, the output buffer 163 deletes one frame.

Specifically, as illustrated in the upper portion of FIG. 6A, upon receiving the buffer control signal, the output buffer 163 deletes the interpolated frame F16-17 that is stored at the head of the output buffer 163. Afterward, as illustrated in the lower portion of FIG. 6A, the output buffer 163 stores therein the original image frame F17, the interpolated frame F17-18, and the original image frame F18 in this order. Thus, the video-signal processing apparatus 100 can output an original image frame and an interpolated frame at original output timing after outputting a predetermined original image frame and an interpolated frame with delay.

Although it is explained above that the output buffer 163 deletes one frame, the output buffer 163 can delete two or more frames or delete all data. For example, as illustrated in FIG. 6B, the output buffer 163 can delete all data if the output buffer 163 receives the buffer control signal from the specific-scene detecting unit 161.

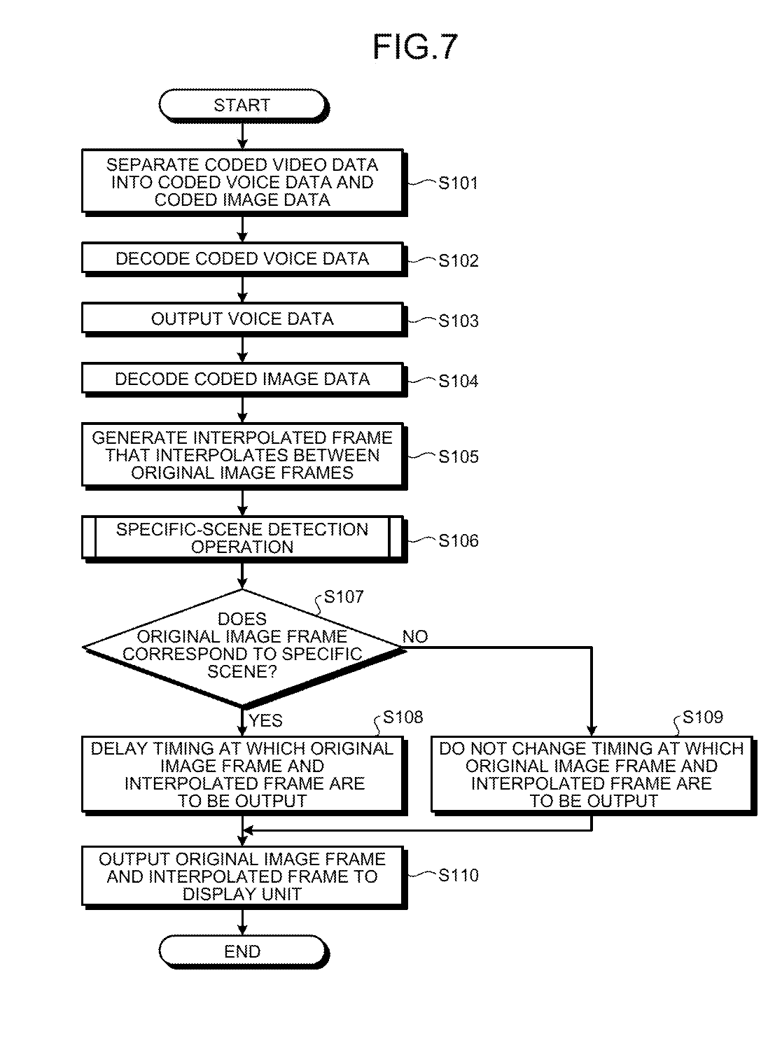

The video signal processing performed by the video-signal processing apparatus 100 will be explained below. FIG. 7 is a flowchart of the video signal processing performed by the video-signal processing apparatus 100. The separating unit 110 separates predetermined coded video data into coded voice data and coded image data (Step S101).

The voice decoding unit 120 then decodes the coded voice data separated by the separating unit 110 (Step S102). The voice output unit 130 outputs voice data decoded by the voice decoding unit 120 via the voice output device (Step S103). In the same manner as the image data, output timing of the voice data is predetermined. The voice output unit 130 then outputs the voice data in accordance with the output timing.

The image decoding unit 140 decodes the coded image data separated by the separating unit 110 (Step S104). The frame interpolation unit 150 generates an interpolated frame that interpolates between original image frames generated by the image decoding unit 140 (Step S105). The frame interpolation unit 150 then outputs the original frame, the interpolated frame, and the movement vector information to the image-frame control unit 160.

The specific-scene detecting unit 161 performs the specific-scene detection operation based on the movement vector information received from the frame interpolation unit 150 (Step S106). The specific-scene detection operation performed by the specific-scene detecting unit 161 will be explained in detail later.

If the specific-scene detecting unit 161 detects that the original image frame corresponds to the specific scene (Yes at Step S107), the output-timing control unit 162 delays timing at which the original image frame and the interpolated frame are to be output to the display unit (Step S108).

On the other hand, if the specific-scene detecting unit 161 detects that the original image frame does not correspond to the specific scene (No at Step S107), the output-timing control unit 162 does not change the timing at which the original image frame and the interpolated frame are to be output to the display unit (Step S109). Specifically, the output-timing control unit 162 controls the original image frame and the interpolated frame to be output to the display unit at the original output timing.

The image display unit 170 outputs the original image frame and the interpolated frame to the display unit (Step S110). The video-signal processing apparatus 100 repeats the above video signal processing until all image frames included in the video data are displayed in the display unit.

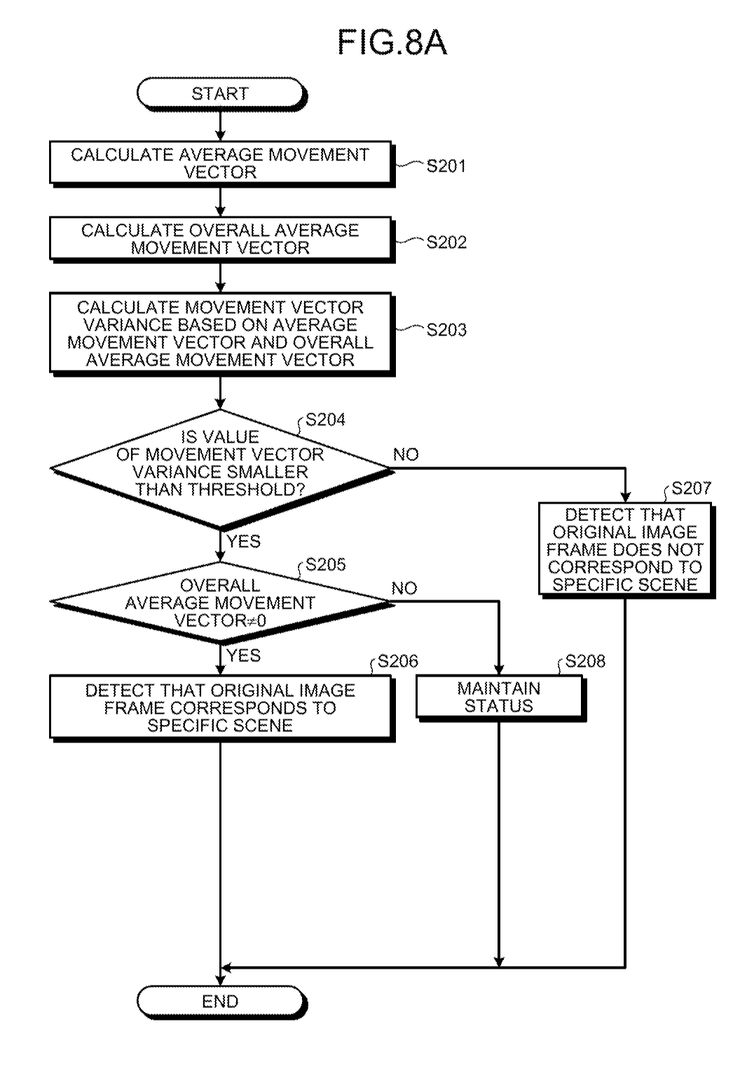

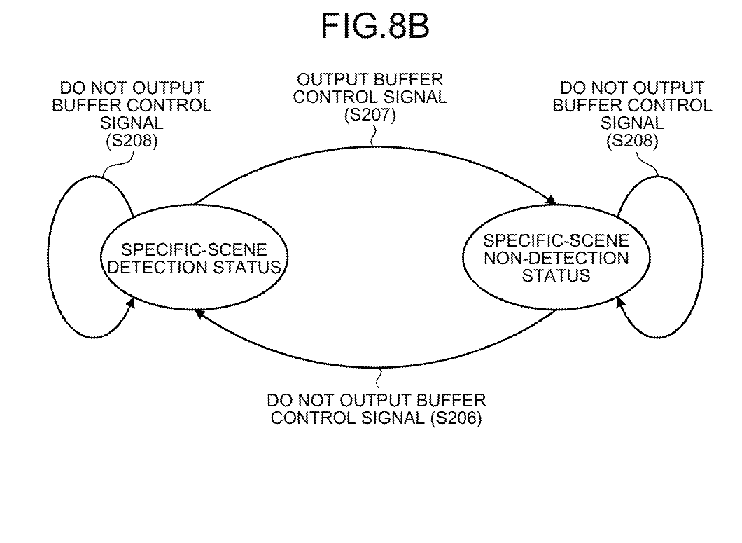

The specific-scene detection operation and detection status control performed by the specific-scene detecting unit 161 will be explained below. FIG. 8A is a flowchart of the specific-scene detection operation performed by the specific-scene detecting unit 161 as depicted in FIG. 3. As depicted in FIG. 8A, the specific-scene detecting unit 161 calculates the average movement vector mvave(i) in the original image frame by each line (in the x-axis direction) based on the movement vector information received from the frame interpolation unit 150 (Step S201).

The specific-scene detecting unit 161 calculates an average value of the average movement vectors mvave(i) thereby calculating the overall average movement vector mvaveall in the original image frame (Step S202). The specific-scene detecting unit 161 then calculates the movement vector variance based on the average movement vector mvave(i) and the overall average movement vector mvaveall (Step S203).

If a value of the movement vector variance is smaller than a threshold (Yes at Step S204) and the overall average movement vector mvaveall is not zero (Yes at Step S205), the specific-scene detecting unit 161 detects that the original image frame corresponds to the specific scene (Step S206).

On the other hand, if the value of the movement vector variance is larger than the threshold (No at Step S204), the specific-scene detecting unit 161 detects that the original image frame does not correspond to the specific scene (Step S207). If the overall average movement vector mvaveall is zero (No at Step S205), the specific-scene detecting unit 161 maintains its status (Step S208).

The specific-scene detecting unit 161 controls its status thereby shifting the status to a specific-scene detection status and a specific-scene non-detection status depending on a condition. FIG. 8B is a transition diagram of the status controlled by the specific-scene detecting unit 161.

The status of the specific-scene detecting unit 161 shifts to the specific-scene detection status at Step S206 represented in FIG. 8A. The status of the specific-scene detecting unit 161 shifts to the specific-scene non-detection status at Step S207 represented in FIG. 8A, and at the same time the specific-scene detecting unit 161 outputs the buffer control signal to the output buffer 163. Upon receiving the buffer control signal, the output buffer 163 deletes all or a part of data stored in the output buffer 163. On the other hand, the status of the specific-scene detecting unit 161 does not shift at Step S208 represented in FIG. 8A.

As described above, in the video-signal processing apparatus 100, every time the original image frame and the interpolated frame are generated, it is determined whether the generated original image frame corresponds to the specific scene and timing at which the original image frame is to be output to the display unit is controlled. Thus, the video-signal processing apparatus 100 can prevent occurrence of noticeable quality degradation if the frame drop occurs with respect to the specific scene. Furthermore, in the video-signal processing apparatus 100, the buffer control signal is output only when the movement vector variance is large, so that an undesired frame can be appropriately deleted when a frame is to be output at original output timing.

Moreover, in the video-signal processing apparatus 100, because a scene in which quality degradation is unnoticeable in the case of the frame drop is output at original output timing, it is possible to display an image almost in real time if the image needs to be displayed in real time. Specifically, the video-signal processing apparatus 100 makes it possible to display an image with smooth movement and display a predetermined image (scene) in real time.

Although it is explained in the above embodiment that the specific-scene detecting unit 161 detects the specific scene based on the movement vector, if the specific scene is determined in advance out of scenes included in an image, the specific-scene detecting unit 161 does not need to perform the specific-scene detection operation. For example, if the N-th original image frame to the M-th original image frame are determined to be the specific scene in advance out of a plurality of original image frames included in an image, the output-timing control unit 162 controls the N-th original image frame to the M-th original image frame and interpolated frames generated based on the N-th original image frame to the M-th original image frame to be output with delay.

Furthermore, although it is explained in the above embodiment that the output timing of the image data is controlled, the output timing of the voice data can be controlled by the video-signal processing apparatus 100 as well as the image data.

All or a part of a processing function performed by each device can be achieved by a central processing unit (CPU) and a computer program analyzed and executed by the CPU or can be achieved as hardware by using a wired logic. For example, each of the units illustrated in FIGS. 2 and 3 can be achieved by using one control circuit (for example, a video-signal control circuit).

The configuration of the video-signal processing apparatus 100 as illustrated in FIG. 2 can be modified in various manners without departing from the scope of the present invention. For example, it is possible that a function performed by each of the units (the separating unit 110, the voice decoding unit 120, the voice output unit 130, the image decoding unit 140, the frame interpolation unit 150, the image-frame control unit 160, and the image display unit 170) included in the video-signal processing apparatus 100 is implemented as software and the software is executed by a computer so that the same function as performed by the video-signal processing apparatus 100 can be achieved. In the following description, an example of a computer that executes a video-signal processing computer program 1071 in which a function performed by each of the units included in the video-signal processing apparatus 100 is implemented as software is explained.

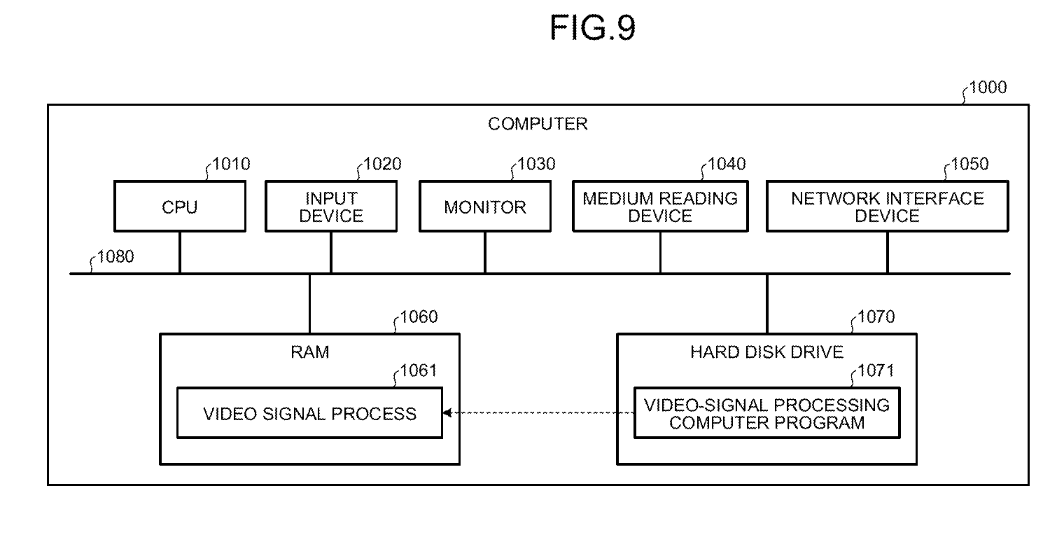

FIG. 9 is a block diagram of a computer 1000 that executes the video-signal processing computer program 1071. The computer 1000 includes a CPU 1010 that executes various arithmetic processing, an input device 1020 that receives data input by a user, a monitor 1030 that displays various information, a medium reading device 1040 that reads a computer program, or the like, from a recording medium, a network interface device 1050 that transmits and receives data to and from a different computer via a network, a RAM (random access memory) 1060 that temporarily stores therein various information, and a hard disk drive 1070. The CPU 1010, the input device 1020, the monitor 1030, the medium reading device 1040, the network interface device 1050, the RAM 1060, and the hard disk drive 1070 are connected to one another via a bus 1080.

The video-signal processing computer program 1071 having the same function as performed by the units (the separating unit 110, the voice decoding unit 120, the voice output unit 130, the image decoding unit 140, the frame interpolation unit 150, the image-frame control unit 160, and the image display unit 170) illustrated in FIG. 2 is stored in the hard disk drive 1070. The CPU 1010 reads the video-signal processing computer program 1071 from the hard disk drive 1070 and expands the read video-signal processing computer program 1071 in the RAM 1060, so that the video-signal processing computer program 1071 functions as a video signal process 1061. Various data processes are executed by the video signal process 1061.

The video-signal processing computer program 1071 does not always need to be stored in the hard disk drive 1070. It is possible that the video-signal processing computer program 1071 is read from a recording medium such as a CD-ROM (compact disk read only memory) by the computer 1000 and the read video-signal processing computer program 1071 is executed by the computer 1000. Moreover, it is possible that the video-signal processing computer program 1071 is stored in a different computer (or a server) connected to the computer 1000 via a public network, the Internet, a LAN (local area network), a WAN (wide area network), or the like, and read from the different computer by the computer 1000, and the read video-signal processing computer program 1071 is executed by the computer 1000.

It is effective to apply components included in the video-signal processing apparatus according to the embodiment, representation about the video-signal processing apparatus, and any combination of the components to a method, a system, a computer program, a recording medium, a data structure, or the like, as another embodiment.

According to the video-signal processing apparatus disclosed in the present application, it is possible to display an image with smooth movement and display a predetermined image almost in real time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A video-signal processing apparatus comprising:
a frame interpolation unit that generates an interpolated frame that interpolates between a first original image frame and a second original image frame, the first original image frame and the second original image frame being generated based on a video signal and to be output to a display unit at first timing;
a specific-scene detecting unit that detects whether the first original image frame and the second original image frame correspond to a specific scene in which an image is moved at a constant speed; and
an output-timing control unit that, if the specific scene is detected by the specific-scene detecting unit, outputs the second original image frame and the interpolated frame generated by the frame interpolation unit to the display unit at second timing with delay from the first timing, and if the specific scene is not detected by the specific-scene detecting unit, outputs the second original image frame and the interpolated frame generated by the frame interpolation unit to the display unit at the first timing.

2. The video-signal processing apparatus according to claim 1, wherein the specific-scene detecting unit detects a movement vector between the first original image frame and the second original image frame and detects whether the second original image frame corresponds to the specific scene based on the movement vector.

3. The video-signal processing apparatus according to claim 2, wherein, based on an average movement vector that is an average value of the movement vector in a lateral direction of the second original image frame and an overall average movement vector that is an average value of all of the average movement vectors in the lateral direction, the specific-scene detecting unit calculates movement vector variance indicating a degree of variation of the average movement vector, and if the movement vector variance is smaller than a threshold and the overall average movement vector is not zero, the specific-scene detecting unit detects that the second original image frame corresponds to the specific scene, and if the movement vector variance is larger than the threshold, the specific-scene detecting unit detects that the second original image frame does not correspond to the specific scene.

4. The video-signal processing apparatus according to claim 3, wherein if the specific-scene detecting unit detects that the second original image frame does not correspond to the specific scene, the specific-scene detecting unit outputs a clear signal to an output buffer.

5. A method for processing a video signal comprising:
generating an interpolated frame that interpolates between a first original image frame and a second original image frame, the first original image frame and the second original image frame being generated based on the video signal and to be output to a display unit at first timing;
detecting whether the first original image frame and the second original image frame correspond to a specific scene in which an image is moved at a constant speed; and
outputting, if the specific scene is detected by the detecting, the second original image frame and the interpolated frame generated by the generating to the display unit at second timing with delay from the first timing, and outputting, if the specific scene is not detected by the detecting, the second original image frame and the interpolated frame generated by the generating to the display unit at the first timing.

6. A video-signal control circuit comprising:
a frame interpolation unit that generates an interpolated frame that interpolates between a first original image frame and a second original image frame, the first original image frame and the second original image frame being generated based on a video signal and to be output to a display unit at first timing;
a specific-scene detecting unit that detects whether the first original image frame and the second original image frame correspond to a specific scene in which an image is moved at a constant speed; and
an output-timing control unit that, if the specific scene is detected by the specific-scene detecting unit, outputs the second original image frame and the interpolated frame generated by the frame interpolation unit to the display unit at second timing with delay from the first timing, and if the specific scene is not detected by the specific-scene detecting unit, outputs the second original image frame and the interpolated frame generated by the frame interpolation unit to the display unit at the first timing.
